(19) United States
(12) Patent Application Publication
(10) Pub. No.: US 2026/0024948 A1
(43) Pub. Date: Jan. 22, 2026

(54) CONNECTOR

(71) Applicant: Japan Aviation Electronics Industry, Limited, Tokyo (JP)

(72) Inventors: Hiroaki KURIBAYASHI, Tokyo (JP); Hideki KIUCHI, Tokyo (JP); Yoshihide KUROKI, Tokyo (JP)

(21) Appl. No.: 19/203,046

(22) Filed: May 8, 2025

(30) Foreign Application Priority Data
Jul. 22, 2024 (JP) 2024-116742

(51) Int. Cl. H01R 13/646

(52) U.S. Cl. CPC H01R 13/646

(57) ABSTRACT

A connector is fitted to a counter connector along a fitting direction and includes a contact pair CP1 consisting of a pair of differential signal contacts adjacent to each other and extending along the fitting direction, a ground layer 15 having conductivity and extending so as to oppose the contact pair CP1, and an insulator retaining the contact pair CP1 and the ground layer 15. The ground layer 15 includes an opening portion 18 disposed at a position opposing the contact pair CP1, and of the opening portion 18, a first width size W1 on a front side in the fitting direction is larger than a second width size W2 on a rear side in the fitting direction, and the second width size W2 is smaller than a width size WP of the contact pair CP1.

### BACKGROUND OF THE INVENTION

The present invention relates to a connector, particularly to a connector including a contact that transmits a signal at high speed.

As a connector including a contact that transmits a signal at high speed, for example, JP 2020-072078 A discloses a connector 1 as shown in FIG. 24. The connector 1 includes a plurality of contacts 2A and a plurality of contacts 2B extending along a fitting direction in the fitting with a counter connector, and a metallic ground plate 3 of flat plate shape. The contacts 2A oppose the contacts 2B in a direction perpendicular to the fitting direction, and the ground plate 3 is situated between the contacts 2A and the contacts 2B. The contacts 2A, the contacts 2B, and the ground plate 3 are retained by an insulator 4.

As shown in FIG. 25, the ground plate 3 is provided with opening portions 5. The opening portions 5 are each formed at a position opposing a contact pair 7 for the purpose of adjusting the characteristic impedance of the contact pair 7 consisting of two signal contacts 6 that are included in the plurality of contacts 2A and 2B and that transmit a signal at high speed.

Meanwhile, when the counter connector is fitted with the connector 1 that is disclosed in JP 2020-072078 A, the connector 1 or the counter connector may be shaky in the fitting due to their manufacturing tolerances or the like, causing variation in insertion depths of counter contacts in the fitting direction relative to the contacts 2A and contacts 2B of the connector 1. The present inventors have found that the characteristic impedance of the contact pair 7 that transmits a signal at high speed would be different between a case where the insertion depth of the counter contact along the fitting direction is shallow and a case where the insertion depth is deep.

### SUMMARY OF THE INVENTION

The present invention has been made in order to solve the conventional problem described above and is aimed at providing a connector capable of reducing variation in the characteristic impedance of the contact pair caused by varied insertion depth of the counter contact along the fitting direction.

The connector according to the present invention is a connector fitted to a counter connector along a fitting direction, the connector comprising: a contact pair consisting of a pair of differential signal contacts adjacent to each other and extending along the fitting direction; a ground layer having conductivity and extending so as to oppose the contact pair; and an insulator retaining the contact pair and the ground layer, wherein the ground layer includes an opening portion disposed at a position opposing the contact pair, and of the opening portion, a first width size on a front side in the fitting direction is larger than a second width size on a rear side in the fitting direction, and the second width size is smaller than a width size of the contact pair.

### BRIEF DESCRIPTION OF THE DRAWINGS

FIG. 1 is a perspective view showing a connector according to Embodiment 1 when viewed from an obliquely upper position.

FIG. 2 is an exploded perspective view of the connector according to Embodiment 1.

FIG. 3 is a perspective view showing a plurality of upper contacts in Embodiment 1 when viewed from an obliquely upper position.

FIG. 4 is a perspective view showing one contact in Embodiment 1 when viewed from an obliquely upper position.

FIG. 5 is a cross-sectional view of the connector according to Embodiment 1 cut along a fitting direction in the fitting with a counter connector.

FIG. 6 is a plan view of a plurality of contacts and a ground plate in Embodiment 1 when superposed and viewed from an upper position.

FIG. 7 is a cross-sectional view of the connector according to Embodiment 1 and the counter connector that are deeply fitted with each other.

FIG. 8 is a cross-sectional view of the connector according to Embodiment 1 and the counter connector that are shallowly fitted with each other.

FIG. 9 is a graph showing an example of simulation calculation of characteristic impedances of a contact pair when the counter contact is deeply fitted with the connector according to Embodiment 1 and when the counter connector is shallowly fitted with the same connector.

FIG. 10 is a plan view showing a ground plate in Comparative Example 1 with respect to Embodiment 1.

FIG. 11 is a graph showing an example of simulation calculation of characteristic impedances of a contact pair in Comparative Example 1.

FIG. 12 is a plan view showing a ground plate in Comparative Example 2 with respect to Embodiment 1.

FIG. 13 is a graph showing an example of simulation calculation of characteristic impedances of a contact pair in Comparative Example 2.

FIG. 14 is a plan view showing part of a ground plate in a modification of Embodiment 1.

FIG. 15 is a plan view showing part of the ground plate in the modification of Embodiment 1 in a further enlarged manner.

FIG. 16 is a plan view showing part of a ground plate in another modification of Embodiment 1.

FIG. 17 is a perspective view of a connector according to Embodiment 2 when viewed from an obliquely upper position.

FIG. 18 is a plan view of a signal contact in Embodiment 2 when viewed from an upper position.

FIG. 19 is a cross-sectional view of the connector according to Embodiment 2 cut along a fitting direction in the fitting with a counter connector.

FIG. 20 is a plan view of the connector according to Embodiment 2 when viewed from an upper position.

FIG. 21 is an enlarged plan view showing part of the connector according to Embodiment 2.

FIG. 22 is a cross-sectional view of the connector according to Embodiment 2 and the counter connector that are deeply fitted with each other.

FIG. 23 is a cross-sectional view of the connector according to Embodiment 2 and the counter connector that are shallowly fitted with each other.

FIG. 24 is a cross-sectional view showing a conventional connector.

FIG. 25 is a plan view showing a ground plate in the conventional connector.

### DETAILED DESCRIPTION OF THE INVENTION

Embodiments of the invention are described below based on the accompanying drawings.

### Embodiment 1

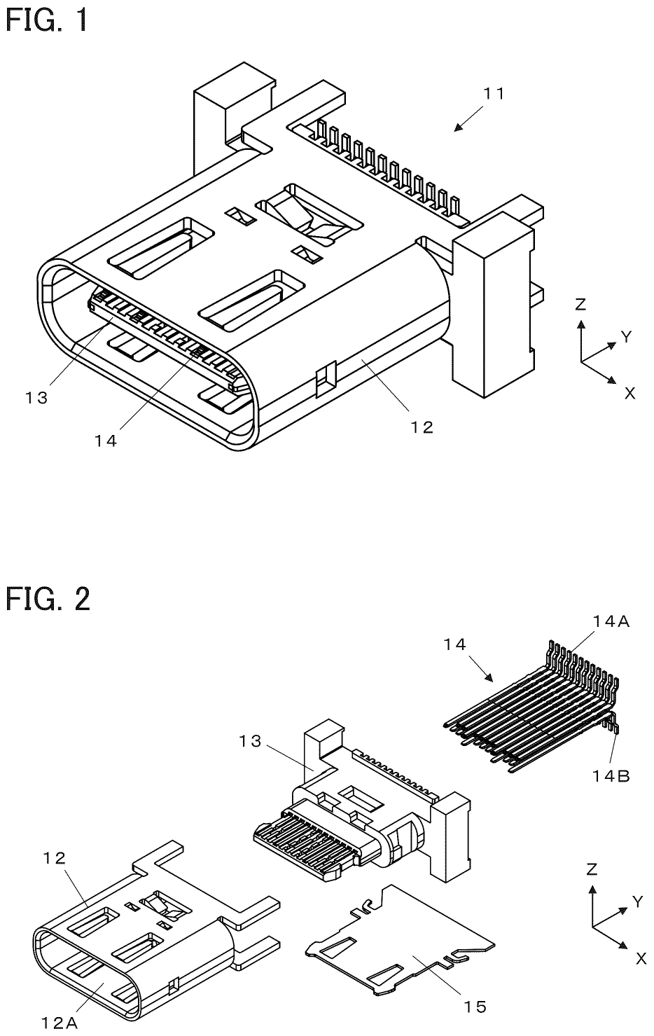

FIG. 1 shows a connector 11 according to Embodiment 1. The connector 11 is a connector to be fixed in an electronic device such as a mobile device or an information appliance and includes a metal shell 12 of tubular shape opening toward a fitting direction in the fitting with a counter connector (not shown). An insulator 13 is disposed in the metal shell 12, and a plurality of contacts 14 are retained by the insulator 13, the contacts 14 being aligned in a width direction of the connector 11 orthogonal to the fitting direction.

For convenience, the fitting direction in the fitting of the connector 11 with the counter connector is referred to as “Y direction,” in particular, the direction in which the metal shell 12 opens as “−Y direction,” the width direction of the connector 11 in which the contacts 14 are aligned as “X direction,” and the height direction of the connector 11 orthogonal to the X direction and the Y direction as “Z direction.”

FIG. 2 shows an exploded view of the connector 11. As shown in the figure, the connector 11 includes a ground plate 15 in addition to the metal shell 12, the insulator 13, and the contacts 14, the ground plate 15 being formed of a metal sheet and serving as an electrically conductive ground layer to be connected to a ground potential when mounted on a substrate. The ground plate 15 is embedded in the insulator 13 as described later.

The metal shell 12 covers a front end of the insulator 13 in the fitting direction, i.e., the −Y directional end, and an outer periphery of the insulator 13 excluding a rear surface portion, i.e., the +Y directional end, and is provided with a counter connector accommodation portion 12A in its tubular shape, the counter connector accommodation portion 12A accommodating the counter connector when the connector 11 is fitted with the counter connector along the Y direction.

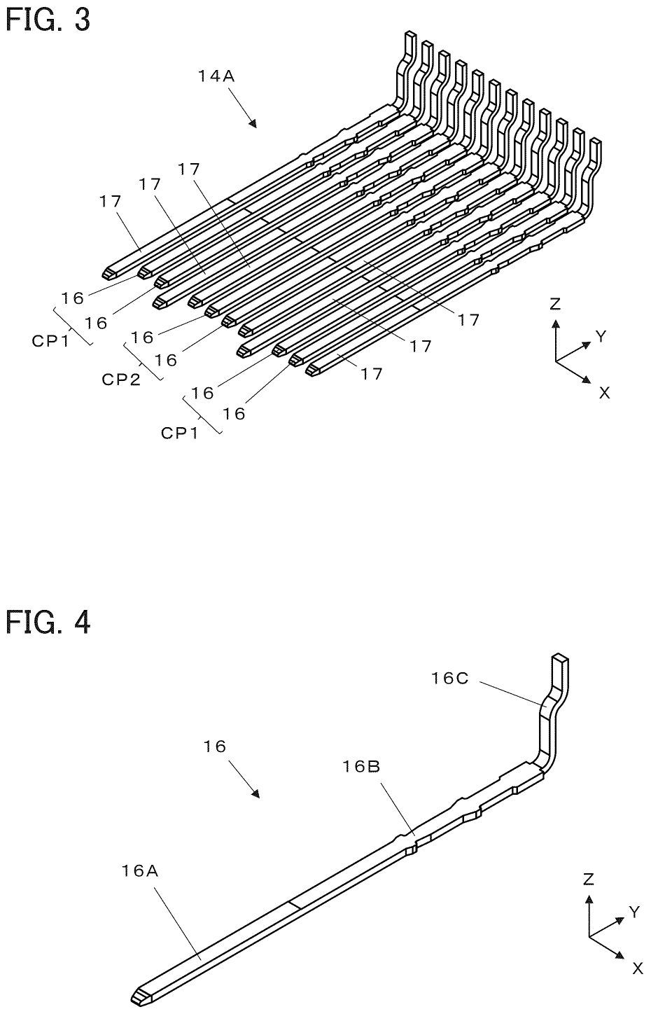

The plurality of contacts 14 comprise a plurality of upper contacts 14A situated on the +Z direction side and retained by the insulator 13, and a plurality of lower contacts 14B situated on the −Z direction side and retained by the insulator 13. As shown in FIG. 3, the upper contacts 14A comprise a plurality of signal contacts 16 for transmitting signals to the counter connector, and a plurality of non-signal contacts 17 for another use than signal transmission. The signal contacts 16 include contact pairs CP1 for high-speed transmission each consisting of a pair of adjacent differential signal contacts, the contact pairs CP1 being separately disposed on the opposite sides in the X direction, and a contact pair CP2 for low-speed transmission consisting of a pair of adjacent signal contacts 16, the contact pair CP2 being disposed on a central portion in the X direction. The plurality of non-signal contacts 17 include, for example, a contact for power supply, a ground contact, and a contact for connector fitting detection.

As shown in FIG. 4, the signal contact 16 constituting the contact pair CP1 for high-speed transmission includes a connection portion 16A situated at a front end, i.e., −Y directional end and exposed from the insulator 13, a retention portion 16B situated at an intermediate portion, the retention portion 16B being embedded and fixed in the insulator 13, and a substrate-mounting portion 16C situated at a rear end, i.e., the +Y directional end and mounted on the substrate. The connection portion 16A is a portion that comes in contact with a contact of the counter connector, and the connection portion 16A and the retention portion 16B linearly extend along the Y direction on an XY plane. The substrate-mounting portion 16C connected to the retention portion 16B protrudes from a rear portion, i.e., the +Y directional end of the insulator 13, bends with respect to the retention portion 16B, and extends in the +Z direction from the bending position. The signal contacts 16 constituting the contact pair CP2 for low-speed transmission and the non-signal contacts 17 also have the same shape as that of the signal contact 16 constituting the contact pairs CP1 for high-speed transmission.

The plurality of lower contacts 14B also comprise a plurality of signal contacts and a plurality of non-signal contacts, as with the upper contacts 14A. The signal contacts and the non-signal contacts of the lower contacts 14B each include the connection portion, the retention portion, and the substrate-mounting portion as with the signal contacts 16 and the non-signal contacts 17 of the upper contacts 14, but the substrate-mounting portion of the lower contact 14B extends in the −Z direction from the bending position where the substrate-mounting portion bends with respect to the retention portion, differently from the substrate-mounting portion 16C of the upper contact 14A.

In the lower contacts 14B, as with the upper contacts 14A, two contact pairs for high-speed transmission each consist of two signal contacts constituting a pair of adjacent differential signal contacts. The two contact pairs CP1 for high-speed transmission of the upper contacts 14A and the two contact pairs for high-speed transmission of the lower contacts 14B are disposed so as to oppose each other in the Z direction.

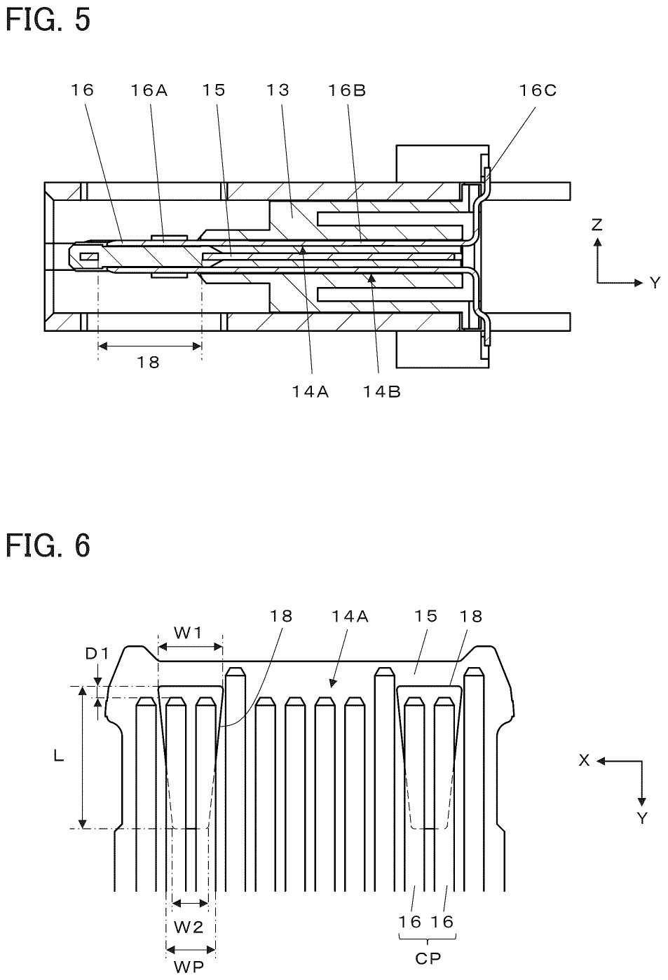

FIG. 5 shows a cross section of the connector 11 cut along a YZ plane passing one of the signal contacts 16 of the contact pair CP1 for high-speed transmission in the upper contacts 14A and the lower signal contact corresponding to the signal contact 16. As shown in the drawing, the ground plate 15 is embedded and fixed in the insulator 13 while being held between the upper contacts 14A and the lower contacts 14B. Hence, the contact pairs CP1 for high-speed transmission are disposed on opposite sides in the Z direction of the ground plate 15 across the ground plate 15.

The ground plate 15 is provided with opening portions 18, each of which is situated at a position facing both of the connection portions 16A of the contact pair CP1 for high-speed transmission on the upper side and the connection portions of the lower contact pair. The opening portions 18 are embedded in the insulator 13 and are formed to adjust the characteristic impedance of the contact pair CP1 for high-speed transmission. More specifically, the opening portion 18 is formed in the ground plate 15 such that the distance between part of the contact pair CP1 overlapping the opening portion 18 and the ground plate 15 is larger than a distance between another part of the contact pair CP1 and the ground plate 15, whereby the capacitance of a capacitor formed between the contact pair CP1 and the ground plate 15 is decreased, being capable of increasing the characteristic impedance of the contact pair CP1.

FIG. 6 is a plan view of the upper contacts 14A and the ground plate 15 that are superposed and viewed from the +Z direction side. The opening portions 18 are formed at positions separately opposing the two contact pairs CP1 for high-speed transmission. The opening portion 18 has a trapezoidal planar shape having a lower base with a first width size W1 along the X direction on the front side in the fitting direction, i.e., the −Y direction side, an upper base with a second width size W2 along the X direction on the rear side in the fitting direction, i.e., the +Y direction side, and a length L along the Y direction. In addition, the −Y directional end of the opening portion 18 is situated apart from the −Y directional end of the contact pair CP1 toward the −Y direction by a distance D1.

Since the opening portion 18 has a trapezoidal planar shape, the first width size W1 is larger than the second width size W2. In addition, the first width size W1 of the opening portion 18 is larger than a width size WP of the contact pair CP1, while the second width size W2 of the opening portion 18 is smaller than the width size WP of the contact pair CP1. The width size WP of the contact pair CP1 refers to the largest width size between the opposite ends of the contact pair CP1 along the X direction in a portion where the contact pair CP1 overlaps the opening portion 18. The opening portion 18 is disposed in a symmetric manner with respect to the center line of the contact pair CP1 along the Y direction.

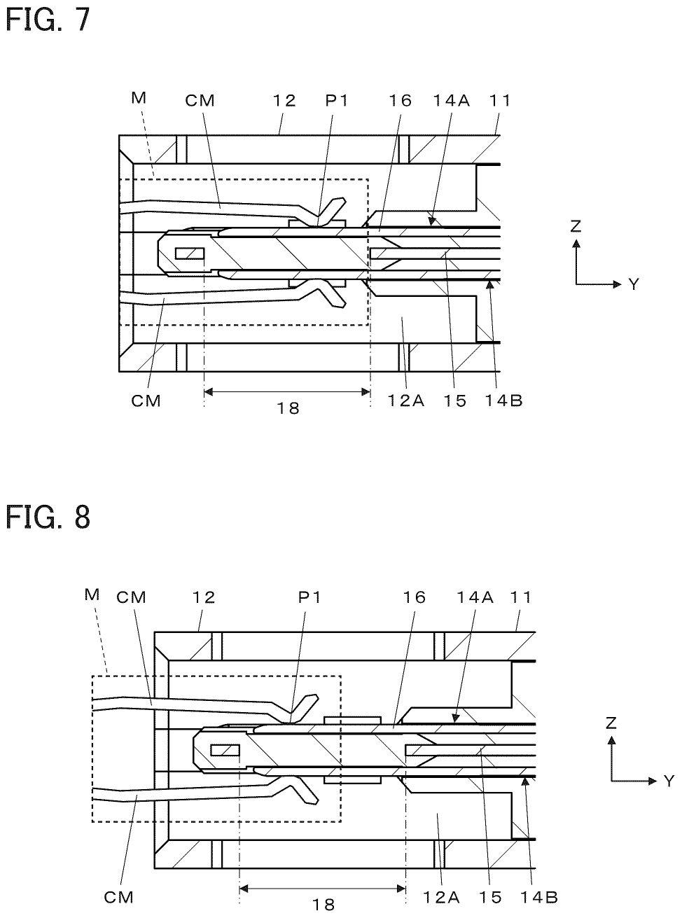

When the counter connector opposing the −Y directional end of the connector 11 moves in the +Y direction to be thereby fitted to the connector 11 along the Y direction, the counter connector M is accommodated in the counter connector accommodation portion 12A of the metal shell 12 of the connector 11 as shown in FIG. 7. In a case where the counter connector M includes a pair of counter contacts CM opposing each other in the Z direction, the pair of counter contacts CM separately come into contact with the signal contact 16 constituting the contact pair CP1 for high-speed transmission included in the upper contacts 14A and the signal contact constituting the contact pair for high-speed transmission included in the lower contacts 14B. In this process, a contact position P1 between the counter contacts CM and the signal contact 16 constituting the contact pair CP1 for high-speed transmission overlaps the opening portion 18 of the ground plate 15 in the Z direction.

Meanwhile, when the connector 11 and the counter connector M are shaky in the fitting due to their manufacturing tolerances or the like, the insertion depth of the counter contacts CM in the Y direction may vary depending on cases such as a case where, as shown in FIG. 7, the counter connector M is deeply fitted with the connector 11 with the counter contacts CM being deeply inserted in the connector 11 along the Y direction, and a case where, as shown in FIG. 8, the counter connector M is shallowly fitted with the connector 11 with the counter contacts CM being shallowly inserted in the connector 11 along the Y direction.

When the counter connector M is fitted with the connector 11, the counter contacts CM come into contact with the signal contact 16 constituting the contact pair CP1 for high-speed transmission. At this time, a portion of the signal contact 16 on the −Y direction side of the contact position P1 contacting with the counter contacts CM serves as a stub for the signal transmission path. As the insertion depth of the counter contacts CM in the Y direction is shallower, the stub is shorter, and as the insertion depth of the counter contacts CM in the Y direction is deeper, the stub is longer. The characteristic impedance of the signal transmission path with a longer stub tends to decrease, and hence the characteristic impedance of the contact pair CP1 tends to vary depending on the insertion depth of the counter contacts CM in the Y direction.

The inventors of the present invention have discovered that by designing the first width size W1 to be larger than the second width size W2 of the opening portion 18 formed in the ground plate 15 as in the trapezoidal planar shape shown in FIG. 6, it is possible to decrease variation in the characteristic impedance of the contact pair CP1 for high-speed transmission caused by varied insertion depth of the counter contacts CM into the connector 11 in the Y direction. The inventors also discovered, as a result of repeated experiments with simulation calculation of the planar shape of the opening portion 18, that by designing the second width size W2 of the opening portion 18 to be smaller than the width size WP of the contact pair CP1 for high-speed transmission as with the opening portion 18 in Embodiment 1, it is possible to further reduce the variation in the characteristic impedance of the contact pair CP1 for high-speed transmission caused by varied insertion depth of the counter contacts CM into the connector 11 in the Y direction.

### EXAMPLES

CST STUDIO SUITE 2021 (available from Dassault Systemes KK) was used to perform simulation calculation of the characteristic impedance of the contact pair CP1 for high-speed transmission in Embodiment 1 as Example 1. In the simulation calculation of Example 1, the frequency of signals transmitted by the contact pair CP1 were 80 GHz. The first width size W1, the second width size W2, and the length L of the opening portion 18 were 1.50 mm, 0.30 mm, and 2.35 mm, respectively. The width size WP of the portion of the contact pair CP1 overlapping the opening portion 18 was 0.76 mm, and the distance D1 between the contact pair CP1 and the −Y directional end of the opening portion 18 along the Y direction was 0.20 mm. The characteristic impedance when the contact position P1 between the counter contacts CM and the contact pair CP1 was apart from the −Y directional end of the opening portion 18 by 0.88 mm along the Y direction was calculated as the case where the insertion depth of the counter contacts CM was shallow, and the characteristic impedance when the contact position P1 between the counter contacts CM and the contact pair CP1 was apart from the −Y directional end of the opening portion 18 by 1.38 mm along the Y direction was calculated as the case where the insertion depth of the counter contacts CM was deep.

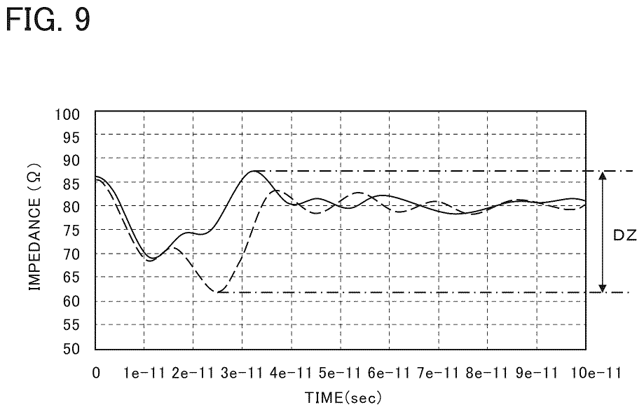

As a result of the simulation, the characteristic impedances shown in FIG. 9 were obtained. The graph with a solid line shows the characteristic impedance of the contact pair CP1 for high-speed transmission when the insertion depth of the counter contacts CM in the Y direction is shallow, and the graph with a dotted line shows the characteristic impedance of the contact pair CP1 for high-speed transmission when the insertion depth of the counter contacts CM in the Y direction is deep. The vertical axis shows impedance, and the horizontal axis shows elapsed time after application of a voltage to the contact pair CP1. The difference DZ between the largest value and the smallest value of the characteristic impedances in these two graphs was 25.26 Ω.

### Comparative Example 1

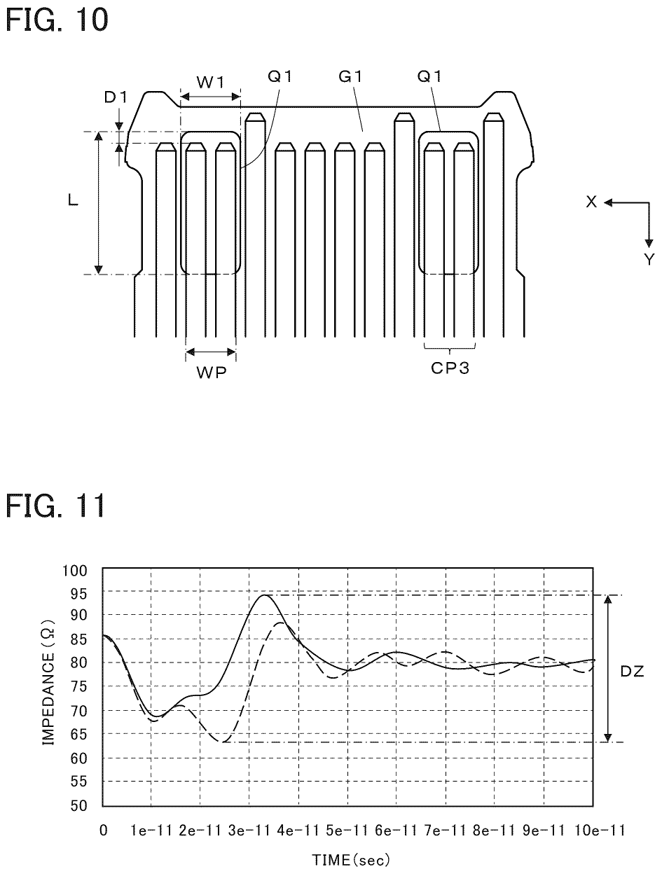

While the opening portion 18 formed in the ground plate 15 in Embodiment 1 of the present invention has a trapezoidal planar shape, for comparison with this embodiment, the characteristic impedance of a contact pair CP3 for high-speed transmission in a case where an opening portion Q1 having a rectangular planar shape was formed in a ground plate G1 as shown in FIG. 10 was calculated through simulation using CST STUDIO SUITE 2021 as Comparative Example 1. The opening portion Q1 has a rectangular planar shape with two sides linearly extending along the X direction and two sides linearly extending along the Y direction. The first width size W1 and the second width size W2 of the opening portion Q1 are equal to each other. The opening portion Q1 is disposed in a symmetric manner with respect to the center line of the contact pair CP3 along the Y direction.

In the simulation in Comparative Example 1, the first width size W1 and the second width size W2 of the opening portion Q1 were 1.20 mm, and the length L thereof was 2.35 mm; other conditions than these changes were the same as those in Example 1.

As a result of the simulation, the characteristic impedances shown in FIG. 11 were obtained. The graph with a solid line shows the characteristic impedance of the contact pair CP3 for high-speed transmission when the insertion depth of the counter contacts CM in the Y direction is shallow, and the graph with a dotted line shows the characteristic impedance of the contact pair CP3 for high-speed transmission when the insertion depth of the counter contacts CM in the Y direction is deep. The difference DZ between the largest value and the smallest value of the characteristic impedances in these two graphs was 30.66 Ω.

### Comparative Example 2

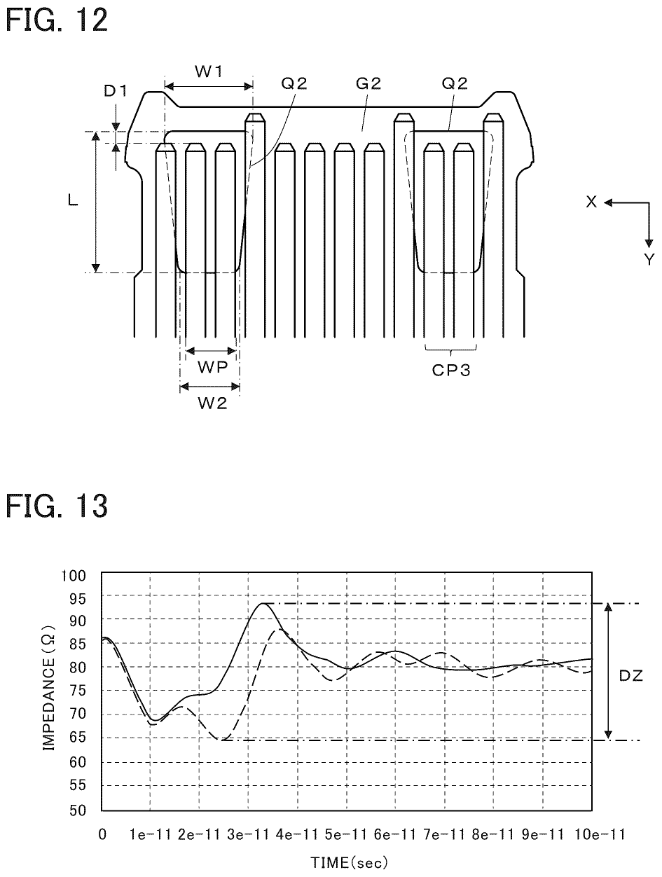

While the second width size W2 of the opening portion 18 formed in the ground plate 15 is smaller than the width size WP of the contact pair CP1 in Embodiment 1 of the present invention, for comparison with this embodiment, the characteristic impedance of the contact pair CP3 in a case where an opening portion Q2 was formed in a ground plate G2 was calculated through simulation using CST STUDIO SUITE 2021 as Comparative Example 2, the opening portion Q2 having a trapezoidal planar shape but having the second width size W2 of the +Y directional end larger than the width size WP of the contact pair CP3 for high-speed transmission as shown in FIG. 12.

In the simulation in Comparative Example 2, the first width size W1 of the opening portion Q2 was 1.50 mm, the second width size W2 of the opening portion Q2 was 1.00 mm being larger than the width size WP (0.76 mm) of the contact pair CP3, and the length L of the opening portion Q2 was 2.35 mm; other conditions than these changes were the same as those in Example 1.

As a result of the simulation, the characteristic impedances shown in FIG. 13 were obtained. The graph with a solid line shows the characteristic impedance of the contact pair CP3 for high-speed transmission when the insertion depth of the counter contacts CM in the Y direction is shallow, and the graph with a dotted line shows the characteristic impedance of the contact pair CP3 for high-speed transmission when the insertion depth of the counter contacts CM in the Y direction is deep. The difference DZ between the largest value and the smallest value of the characteristic impedances in these two graphs was 29.16 Ω. Hereinbelow, this example of simulation calculation is referred to as Comparative Example 2.

### Comparative Example 3

Although not shown in the drawings, as Comparative Example 3, simulation calculation was performed with the same parameters as those of Comparative Example 2 except that the second width size W2 of the opening portion Q2 and the width size WP of the contact pair CP3 were both 0.76 mm, and the difference DZ between the largest value and the smallest value of the characteristic impedance of the contact pair CP3 for high-speed transmission when the insertion depth of the counter contacts CM in the Y direction is shallow and the characteristic impedance of the contact pair CP3 for high-speed transmission when the insertion depth of the counter contacts CM in the Y direction is deep was 27.30 Ω. Hereinbelow, this example of simulation calculation is referred to as Comparative Example 3.

Calculation results of Example 1, and Comparative Examples 1 to 3 are shown in Table 1 below.

TABLE 1

| | | | | | Largest | Smallest | Difference |
|---|---|---|---|---|---|---|---|
| | Planar | | | Width size | value of | value of | DZ in |
| | shape of | First | Second | of contact | characteristic | characteristic | characteristic |
| | opening | width size | width size | pair | impedance | impedance | impedance |
| | portion | W1 (mm) | W2 (mm) | WP (mm) | (Ω) | (Ω) | (Ω) |
| Example 1 | Trapezoid | 1.50 | 0.30 | 0.76 | 87.24 | 61.98 | 25.26 |
| Comparative | Rectangle | 1.20 | 1.20 | 0.76 | 94.17 | 63.51 | 30.66 |
| Example 1 | | | | | | | |
| Comparative | Trapezoid | 1.50 | 1.00 | 0.76 | 93.54 | 64.38 | 29.16 |
| Example 2 | | | | | | | |
| Comparative | Trapezoid | 1.50 | 0.76 | 0.76 | 90.58 | 63.28 | 27.30 |
| Example 3 | | | | | | | |

These results teach that the difference DZ in the characteristic impedance can be reduced when the first width size W1 is larger than the second width size W2 of the opening portion 18 formed in the ground plate 15. In addition, the difference DZ in the characteristic impedance can be further reduced when the second width size W2 is smaller than the width size WP of the contact pair CP1. As described above, it is found that variation in the characteristic impedance of the contact pair CP1 caused by varied insertion depth of the counter contacts CM in the Y direction can be reduced by designing such that, of the opening portion 18 formed in the ground plate 15, the first width size W1 is larger than the second width size W2, and that the second width size W2 is smaller than the width size WP of the contact pair CP1.

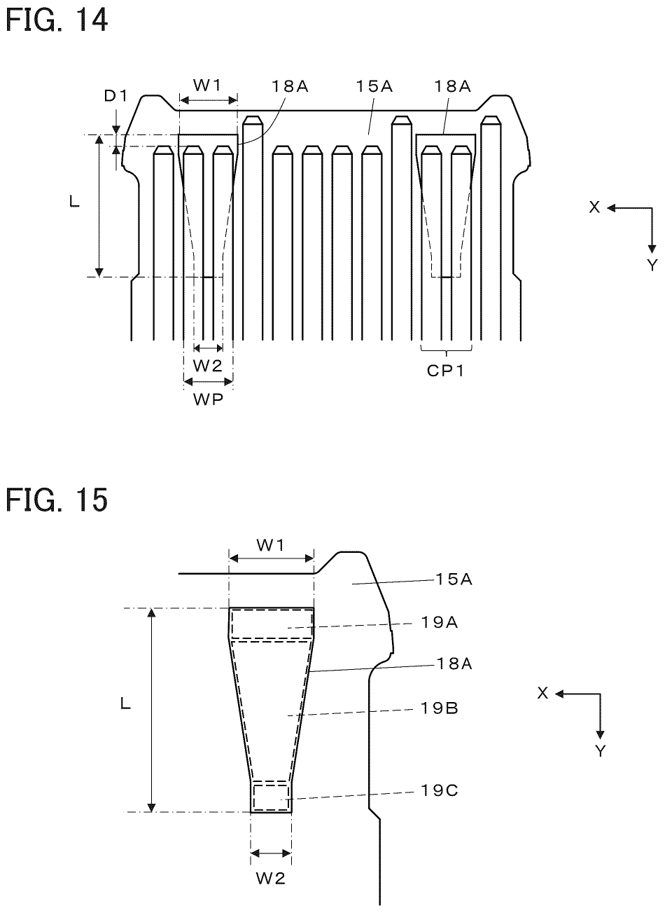

While it has been described that the opening portion 18 having a trapezoidal planar shape is formed in the ground plate 15, the planar shape of the opening portion 18 is not limited to trapezoid. As shown in FIGS. 14 and 15, for instance, an opening portion 18A may have a shape formed by joining a first rectangular portion 19A having two sides extending along the X direction and having a first width size W1, a trapezoidal portion 19B having a lower base with a first width size W1 and an upper base with a second width size W2, and a second rectangular portion 19C having two sides extending along the X direction and a second width size W2 together. The +Y directional end of the first rectangular portion 19A is joined to the −Y directional end of the trapezoidal portion 19B, and the +Y directional end of the trapezoidal portion 19B is joined to the −Y directional end of the second rectangular portion 19C. Since steps are formed at the X direction sides of this shape, such shape is conveniently called “stepped trapezoidal shape” below. The opening portion 18A is disposed in a symmetric manner with respect to the center line of the contact pair CP1 along the Y direction. Although the first rectangular portion 19A, the trapezoidal portion 19B, and the second rectangular portion 19C have outlines overlapping the outline of the planar shape of the opening portion 18A in reality, FIG. 15 shows the outlines of the first rectangular portion 19A, the trapezoidal portion 19B, and the second rectangular portion 19C with dotted lines to be smaller than their actual outlines for explanation.

### EXAMPLE 2

The characteristic impedance of the contact pair CP1 for high-speed transmission in a case where the opening portion 18A has a stepped trapezoidal planar shape as above was calculated through simulation using CST STUDIO SUITE 2021 as Example 2.

In Example 2, the opening portion 18A of stepped trapezoidal planar shape had the first width size W1 of 1.50 mm, the second width size W2 of 0.30 mm, and the length L of 2.35 mm, while other conditions were the same as those in Example 1. As a result of this simulation calculation, the difference DZ in the characteristic impedance was 24.92 Ω.

### Comparative Example 4

As Comparative Example 4, the characteristic impedance was calculated with the second width size W2 in Example 2 being changed to 1.00 mm to be larger than the width size WP (0.76 mm) of the contact pair CP1. As a result, the difference DZ in the characteristic impedance was 29.29 Ω.

### Comparative Example 5

As Comparative Example 5, the characteristic impedance was calculated with the second width size W2 in Example 2 being changed to 0.76 mm to be the same as the width size WP of the contact pair CP1. As a result, the difference DZ in the characteristic impedance was 27.80 Ω. The calculation results of Example 2, and Comparative Examples 1, 4, and 5 are shown in Table 2 below.

TABLE 2

| | | | | | Largest | Smallest | Difference |
|---|---|---|---|---|---|---|---|
| | Planar | | | Width size | value of | value of | DZ in |
| | shape of | First | Second | of contact | characteristic | characteristic | characteristic |
| | opening | width size | width size | pair | impedance | impedance | impedance |
| | portion | W1 (mm) | W2 (mm) | WP (mm) | (Ω) | (Ω) | (Ω) |
| Example 2 | Stepped | 1.50 | 0.30 | 0.76 | 87.33 | 62.41 | 24.92 |
| | trapezoid | | | | | | |
| Comparative | Rectangle | 1.20 | 1.20 | 0.76 | 94.17 | 63.51 | 30.66 |
| Example 1 | | | | | | | |
| Comparative | Stepped | 1.50 | 1.00 | 0.76 | 93.78 | 64.49 | 29.29 |
| Example 4 | trapezoid | | | | | | |
| Comparative | Stepped | 1.50 | 0.76 | 0.76 | 91.74 | 63.94 | 27.80 |
| Example 5 | trapezoid | | | | | | |

The results teach that even when the opening portion 18A formed in the ground plate 15A has a stepped trapezoidal planar shape, variation in the characteristic impedance of the contact pair CP1 caused by varied insertion depth of the counter contacts CM in the Y direction can be reduced by designing such that the first width size W1 is larger than the second width size W2 in the opening portion 18A, and that the second width size W2 is smaller than the width size WP of the contact pair CP1.

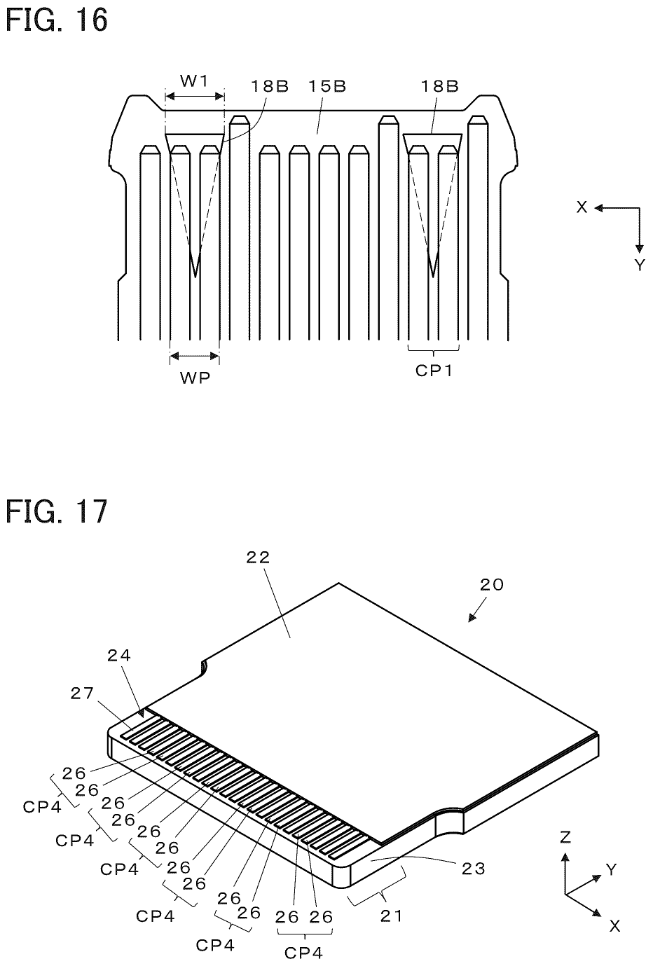

As shown in FIG. 16, for instance, an opening portion 18B can also have a triangle planar shape whose −Y directional end is the lower base having the first width size W1. In this case, since the second width size W2 at the +Y directional end of the opening portion 18B is smaller than the first width size W1 and the width size WP of the contact pair CP1, variation in the characteristic impedance of the contact pair CP1 for high-speed transmission caused by varied insertion depth of the counter contacts CM can be reduced.

It has been described above that the planar shape of the opening portion 18 formed in the ground plate 15 is not particularly limited as long as the first width size W1 is larger than the second width size W2 and the second width size W2 is smaller than the width size WP of the contact pair CP1 for high-speed transmission; meanwhile, the planar shape of the opening portion 18 is preferably a shape with the width size along the X direction uniformly decreasing from the front side toward the rear side in the fitting direction, i.e., from the −Y directional end toward the +Y directional end. When the opening portion 18 has such planar shape, the largest value and the smallest value of the characteristic impedance of the contact pair CP1 tend to uniformly change over time as the insertion depth of the counter contacts CM along the Y direction gradually becomes deeper or gradually shallower; hence, the characteristic impedance of the contact pair CP1 can be prevented from largely varying depending on a specific insertion depth of the counter contacts CM. Therefore, for instance, the characteristic impedance of the contact pair CP1 can be easily adjusted in accordance with the specification required by, e.g., a device on which the connector 11 is mounted.

As examples of the planar shape of the opening portion 18, shapes with the X directional sides being linear lines and bent lines formed of combined linear lines have been described; meanwhile, the X directional sides may be curved lines.

In addition, an example where two contact pairs CP1 are included in a plurality of upper contacts 14A and in a plurality of lower contacts 14B has been described; meanwhile, only a single contact pair or three or more contact pairs may be included in the upper contacts 14A and in the lower contacts 14B. In these cases, the ground plate 15 may be provided with the same number of opening portions 18 as the number of contact pairs CP1, e.g., only one opening portion 18 or three or more opening portions 18. Moreover, it has been described that the connector 11 includes the plurality of upper contacts 14A and the plurality of lower contacts 14B; meanwhile, the connector 11 may include only the plurality of upper contacts 14A or only the lower contacts 14B.

### Embodiment 2

While the connector 11 including the metal shell 12 has been described in Embodiment 1, the invention may be applied to a so-called card edge connector that is mounted on a circuit board.

FIG. 17 shows a connector 21 according to Embodiment 2. The connector 21 is a card edge connector which is formed at a −Y directional end portion of a printed circuit board 20 extending in an XY plane to form a flat plate shape and having a thickness in the Z direction, and which comprises a connection portion to be connected with the counter connector M. The connector 21 includes an insulator 23 forming a board body of the printed circuit board 20 and a plurality of contacts 24 formed on the insulator 23. The printed circuit board 20 includes a resist layer 22 covering and protecting an electronic circuit (not shown) connected to the contacts 24.

The plurality of contacts 24 include 12 signal contacts 26 used for high-speed signal transmission and a plurality of non-signal contacts 27 other than the signal contacts 26. The 12 signal contacts 26 constitute six contact pairs CP4, each of the contact pairs CP4 consisting of two adjacent signal contacts 26 forming a pair of differential signal contacts.

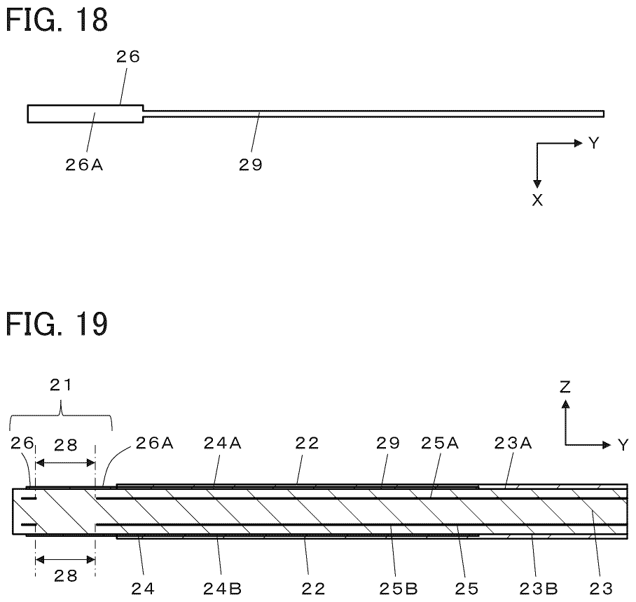

As shown in FIG. 18, the signal contact 26 includes at its front end in the fitting direction, i.e., the −Y direction end thereof a connection portion 26A formed on the insulator 23 and constituted of a conductive pad exposed from the resist layer 22. A retention portion 29 extends from the +Y directional end of the connection portion 26A, the retention portion 29 being formed on the insulator 23, connected to the electronic circuit of the printed circuit board 20, and covered by the resist layer 22.

As shown in FIG. 19, the plurality of contacts 24 are composed of a plurality of upper contacts 24A situated on the +Z direction side of the insulator 23 and a plurality of lower contacts 24B situated on the −Z direction side of the insulator 23, and are covered by the resist layer 22 except their −Y directional end portions. The upper contacts 24A are formed on a first surface 23A situated on the +Z direction side of the insulator 23, and the lower contacts 24B are formed on a second surface 23B situated on the −Z direction side of the insulator 23.

The connector 21 also includes, as a ground layer, a conductive layer 25 which is composed of an upper conductive layer 25A and a lower conductive layer 25B disposed in the board body that is formed of the insulator 23. The upper conductive layer 25A and the lower conductive layer 25B are each provided with an opening portion 28 at a position opposing the connection portions 26A of the upper contact pair CP4 or the connection portions 26B of the lower contact pair CP4.

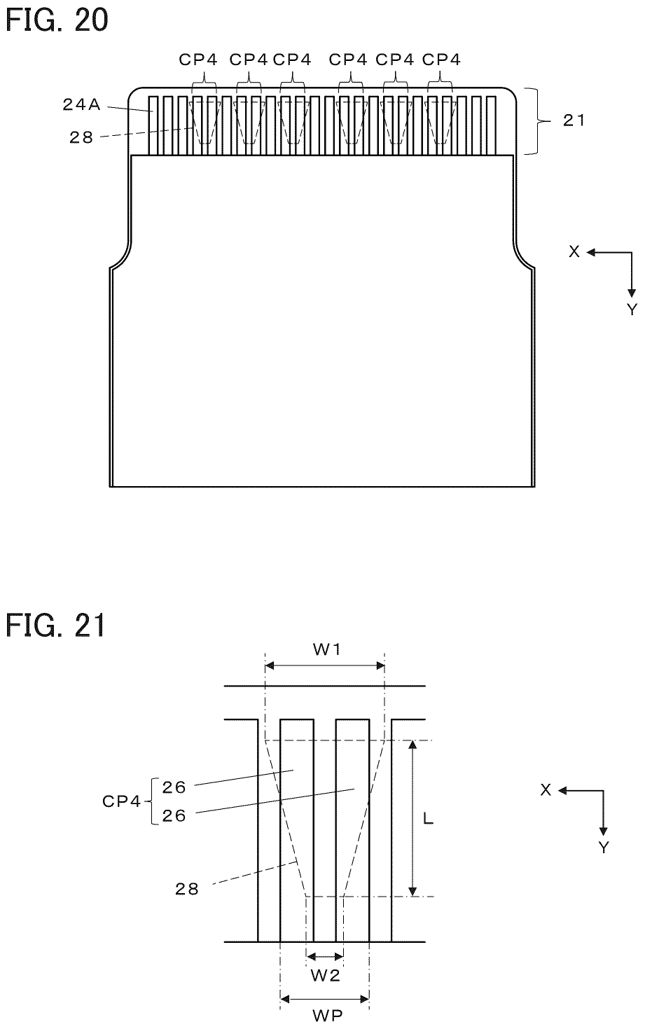

FIG. 20 is a plan view of the connector 21 when viewed from the +Z direction side and shows six opening portions 28 of the upper conductive layer 25A with dashed lines. The opening portions 28 are disposed at positions independently opposing the six contact pairs CP4. As being enlarged and shown in FIG. 21, the opening portion 28 has a trapezoidal planar shape having a lower base with a first width size W1 along the X direction on a front side in the fitting direction, i.e., the −Y direction side, an upper base with a second width size W2 along the X direction on a rear side in the fitting direction, i.e., the +Y direction side, and a length L along the Y direction. The first width size W1 is larger than the second width size W2 in the opening portion 28, and the second width size W2 of the opening portion 28 is smaller than a width size WP of the contact pair CP4.

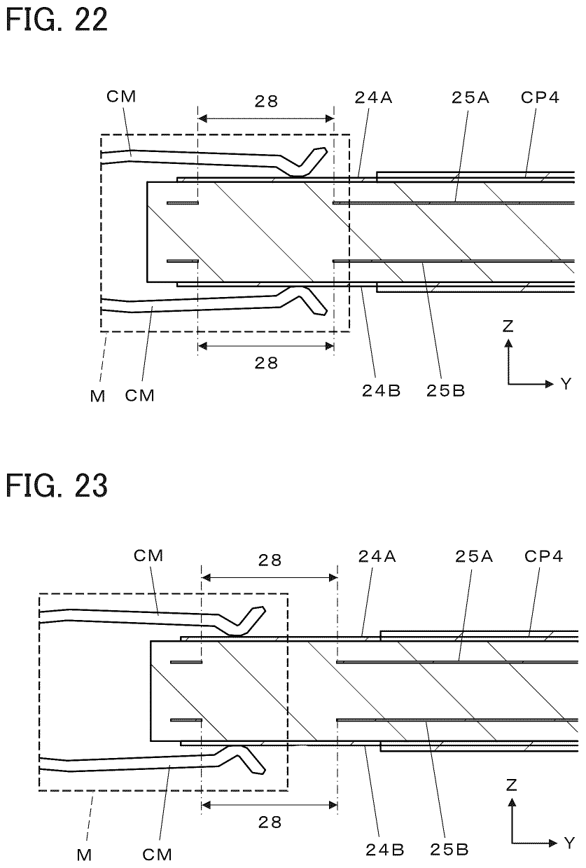

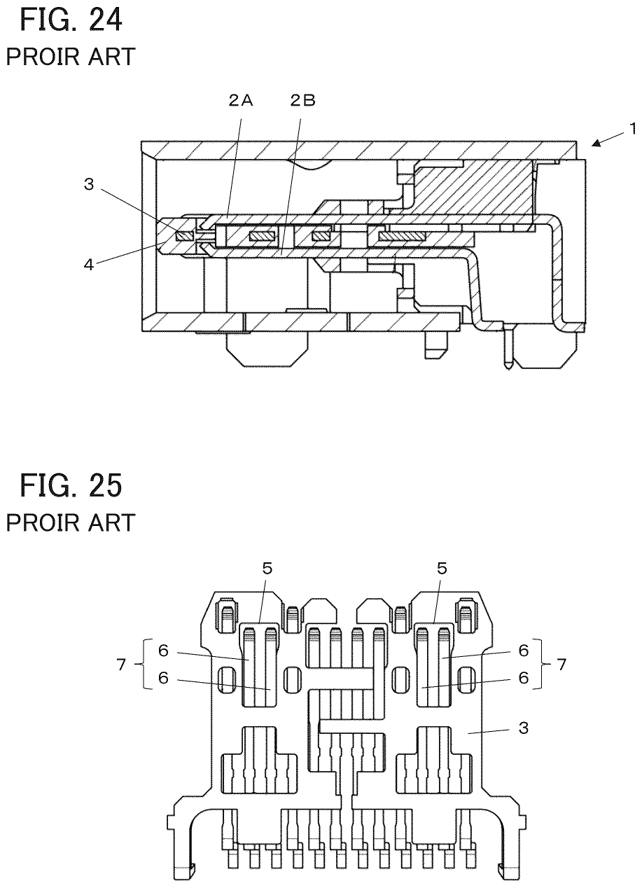

The opening portion 28 in the lower conductive layer 25B has the same shape as that of the opening portion 28 in the upper conductive layer 25A. Since the first width size W1 is larger than the second width size W2 in the opening portions 28 in the upper conductive layer 25A and the lower conductive layer 25B while the second width size W2 is smaller than the width size WP of the contact pair CP4, the connector 21 in Embodiment 2, as with the connector 11 in Embodiment 1, can reduce variation in characteristic impedance of the contact CP4 for high-speed transmission between a case where the insertion depth of the counter contacts CM is deep as shown in FIG. 22, for example, and a case where the insertion depth of the counter contacts CM is shallow as shown in FIG. 23, for example.

An example where six contact pairs CP4 are included in the upper contacts 24A and in the lower contacts 24B has been described; meanwhile, for instance, a single contact pair CP4, two to five contact pairs CP4, or seven or more contact pairs CP4 may be included in the upper contacts 24A and in the lower contacts 24B. In these cases, each of the upper conductive layer 25A and the lower conductive layer 25B can be provided with, for instance, only one, two to five, or seven or more opening portions 28 such that the number of opening portions 28 corresponds to the number of the contact pairs CP4 included in the upper contacts 24A or the lower contacts 24B.

In addition, it has been described that the plurality of contacts 24 include the upper contacts 24A and the lower contacts 24B; meanwhile, the contacts 24 may include only the upper contacts 24A or the lower contacts 24B. In this case, the connector 21 includes only the upper conductive layer 25A or the lower conductive layer 25B.

Moreover, it has been described that the opening portion 28 has a trapezoidal planar shape in Embodiment 2; meanwhile, the planar shape of the opening portion 28 is not limited to a trapezoidal shape as long as the first width size W1 is larger than the second width size W2 while the second width size W2 is smaller than the width size WP of the contact pair CP4, as with the opening portion 18 in Embodiment 1.

What is claimed is:

1. A connector fitted to a counter connector along a fitting direction,
the connector comprising:
a contact pair consisting of a pair of differential signal contacts adjacent to each other and extending along the fitting direction;
a ground layer having conductivity and extending so as to oppose the contact pair; and
an insulator retaining the contact pair and the ground layer,
wherein the ground layer includes an opening portion disposed at a position opposing the contact pair, and of the opening portion, a first width size on a front side in the fitting direction is larger than a second width size on a rear side in the fitting direction, and the second width size is smaller than a width size of the contact pair.

2. The connector according to claim 1,
wherein the pair of differential signal contacts constituting the contact pair include connection portions extending along the fitting direction, disposed at a front end in the fitting direction, and exposed from the insulator, and
when the connector is fitted with the counter connector, the connection portions of the pair of differential signal contacts are in contact with a pair of counter contacts of the counter connector.

3. The connector according to claim 2, wherein the opening portion of the ground layer is disposed at a position opposing the connection portions of the pair of differential signal contacts and is embedded in the insulator.

4. The connector according to claim 3, comprising, as the ground layer, a ground plate formed of a metal sheet.

5. The connector according to claim 4,
wherein the pair of differential signal contacts each include:
a mounting portion disposed at a rear end in the fitting direction and exposed from the insulator; and
a retention portion disposed between the connection portion and the mounting portion and embedded in and retained by the insulator.

6. The connector according to claim 4, comprising a plurality of contact pairs, each of the contact pairs consisting of the pair of differential signal contacts,
wherein the ground plate includes a plurality of opening portions corresponding to the plurality of contact pairs and disposed at positions separately opposing the plurality of contact pairs, and
of each of the plurality of opening portions, the first width size on a front side in the fitting direction is larger than the second width size on a rear side in the fitting direction, and the second width size is smaller than a width size of the contact pair corresponding thereto.

7. The connector according to claim 4, wherein the contact pairs are separately disposed on opposite sides of the ground plate across the ground plate.

8. The connector according to claim 3,
wherein the insulator forms a board body of a printed circuit board,
the connection portions of the pair of differential signal contacts are each formed of a conductive pad formed in the board body,
the ground layer is formed of a conductive layer disposed in the board body, and the connector forms a card edge connector.

9. The connector according to claim 8, comprising a plurality of contact pairs, each of the contact pairs consisting of the pair of differential signal contacts,
wherein the ground layer includes a plurality of opening portions corresponding to the plurality of contact pairs and disposed at positions separately opposing the plurality of contact pairs, and
of each of the plurality of opening portions, the first width size on a front side in the fitting direction is larger than the second width size on a rear side in the fitting direction, and the second width size is smaller than a width size of the contact pair corresponding thereto.

10. The connector according to claim 8,
wherein the contact pair is disposed on each of opposite surfaces of the board body, and
a pair of the ground layers are disposed in the board body to each correspond to the contact pair disposed on each of the opposite surfaces of the board body.

11. The connector according to claim 1, wherein the first width size is larger than a width size of the contact pair.

12. The connector according to claim 11, wherein the opening portion has a trapezoidal planar shape.
